(19) United States
(12) Patent Application Publication
(10) Pub. No.: US 2003/0041226 A1
(43) Pub. Date: Feb. 27, 2003

(54) Electronic switch with code learning and decoding functions

(75) Inventors: Kuo-Ping Yang, Taipei (TW); Ching Hsiang Shih, Taipei (TW); Ho-Hsin Liao, Taipei (TW)

Correspondence Address: BACON & THOMAS, PLLC, 625 SLATERS LANE, FOURTH FLOOR, ALEXANDRIA, VA, 22314

(73) Assignee: Kuo-Ping YANG, Taipei (TW)

(21) Appl. No.: 09/934,708

(22) Filed: Aug. 23, 2001

(51) Int. Cl. G06F 15/00; G06F 15/76; G06F 7/38; G06F 9/00; G06F 9/44

(52) U.S. Cl. 712/43; 712/229

(57) ABSTRACT

An electronic switch is has a receiver for receiving external switch signal and to producing corresponding switch control signal. A decoder us provided to receive switch control signal from the receiver and to produce corresponding decoding signal containing a switch identification code. A memory stores at least one switch identification code, each switch PIN code corresponding to a respective switch element. A processor is provided to compare switch identification code from the decoder with switch PIN code in the memory and to turn on the corresponding switch element when the switch identification codes are matched. The processor has a learning mode for writing every received switch identification code from the decoder into the memory and corresponding every written switch PIN code to the at least one switch element respectively.

### BACKGROUND OF THE INVENTION

1. Field of the Invention

The present invention relates to an electronic switch and, more particularly, to such an electronic switch that have code learning and decoding functions.

2. Description of Related Art

Following fast development of electrical apparatus, the convenience of living of human beings is relatively improved. When using an electrical apparatus, an associated switch device must be turned on and operated to regulate the electrical apparatus properly. Because there may be a variety of electrical apparatuses in a family or company and installed in different corners of the house, it is inconvenient to control the respective switch of every electrical apparatus in the house, particularly to the disabled or old persons. In order to eliminate this problem, different remote-controlled electronic switches are developed. FIG. 5 shows a remote-controlled electronic switch according to the prior art. This structure of remote-controlled electronic switch comprises an electronic switch 51 and a remote-controller 52. The electronic switch 51 is connected to an electric outlet (not shown). The electric apparatus 53 is connected to a socket 511 in the electronic switch 51. Operating the remote-controller 52 drives the electronic switch 51 to control the operation of the electric apparatus 53.

The aforementioned structure of remote-controlled electronic switch is convenient in use, however the electronic switch 51 and the remote-controller 52 are arranged in an one-to-one manner; i.e., one remote-controller 52 is used to control one particular electronic switch 52. When controlling a number of electrical apparatuses, multiple remote-controlled electronic switches shall be used. There are also known designs that use one remote-controller to control multiple electronic switches. However the installation and setting procedures of these designs are complicated.

Therefore, it is desirable to provide an electronic switch that eliminates the aforesaid drawbacks.

### SUMMARY OF THE INVENTION

The object of the present invention is to provide an electronic switch, which has code learning and decoding functions to conveniently and effectively control different electric apparatus.

To achieve the object, the electronic switch with code learning and decoding functions in accordance with the present invention comprises: at least one switch element; a receiver for receiving an external switch signal and producing a switch control signal upon receipt of an external switch signal; a decoder for receiving switch control signal from said receiver and producing a decoding signal containing a switch identification code upon receipt of switch control signal from said receiver; a memory for storing at least one switch identification code, each corresponding to said at least one switch element, respectively; and a processor for comparing outputted switch identification code from said decoder with the at least one switch identification code stored in said memory and to turn on the corresponding switch element when the switch identification codes are matched, wherein the processor has a learning mode for writing every received switch identification code from the decoder into said memory and for corresponding every written switch identification code to said at least one switch element, respectively.

Other objects, advantages, and novel features of the invention will become more apparent from the following detailed description when taken in conjunction with the accompanying drawings.

### BRIEF DESCRIPTION OF THE DRAWINGS

FIG. 1 is the block diagram of an electronic switch with code learning and decoding functions according to a preferred embodiment of the present invention.

FIG. 2 is a block diagram of an alternate form of the electronic switch with code learning and decoding functions according to another preferred embodiment of the present invention.

FIG. 3 is an implementation example of the electronic switch with code learning and decoding functions according to the present invention.

FIG. 4 is another implementation example of the electronic switch code learning and decoding functions according to the present invention.

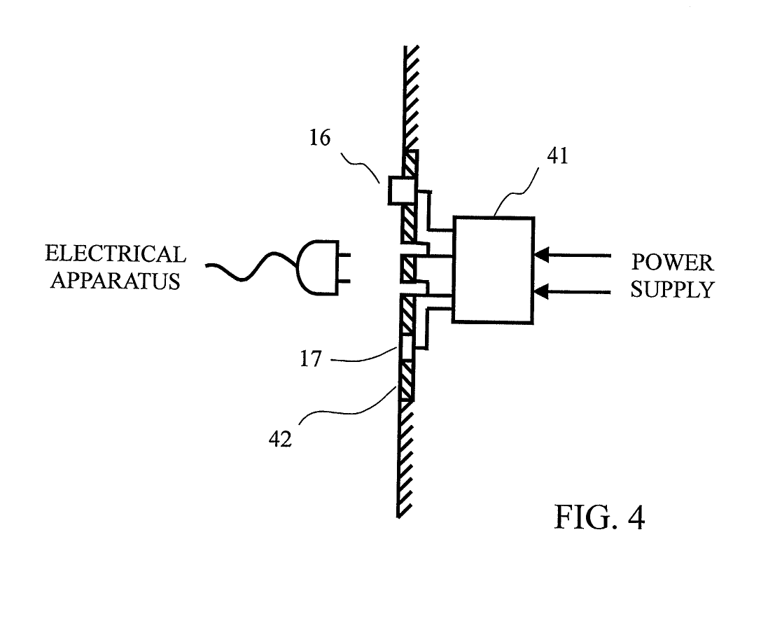

FIG. 5 illustrates the installation and use of a remote-controlled electronic switch according to the prior art.

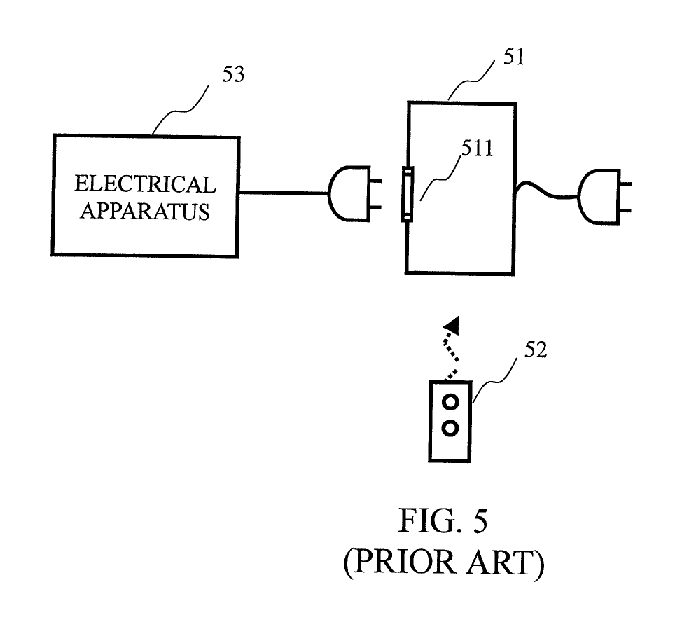

### DETAILED DESCRIPTION OF THE PREFERRED EMBODIMENT

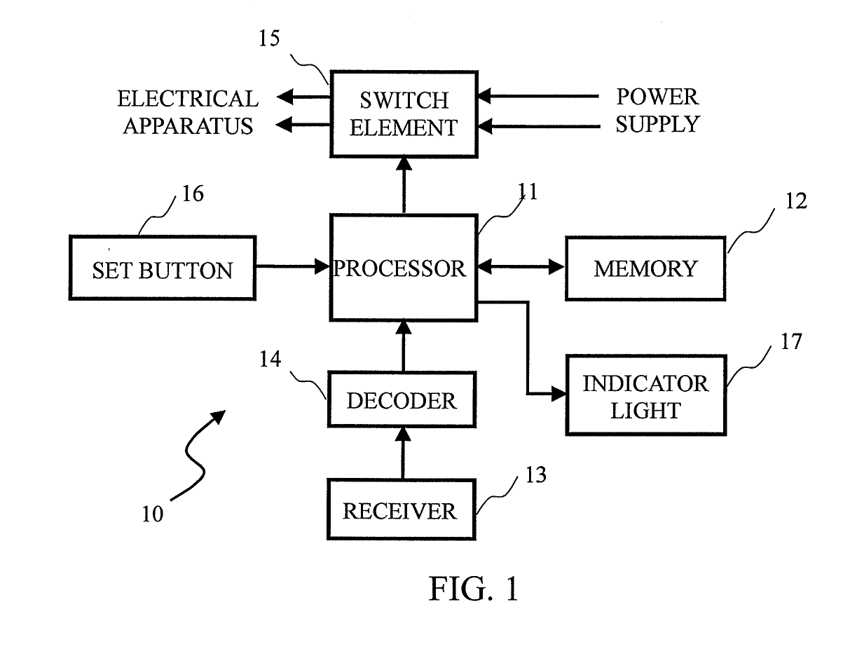

With reference to FIG. 1, an electronic switch 10 with code learning and decoding functions constructed according to the present invention is generally comprised of a processor 11, a memory 12, a receiver 13, a decoder 14, at least one switch element 15, a set button 16, and at least one indicator light 17. By means of operating a remote-controller (not shown) to switch on/off the switch element 15, it is able to determine whether power is supplied to the electrical apparatus.

The receiver 13 is preferably an infrared or radio receiver for receiving infrared or radio switching signal from the remote-controller and to produce switching control signal.

The decoder 14 is provided to produce decoding signal containing a switch identification code upon receipt of switching control signal from the receiver 13.

The memory 12 is preferably a flash memory or EEPROM (electronically erasable programmable read-only memory) having stored therein at least one switch identification code corresponding to a respective switch element 15.

The processor 11 is preferably a microprocessor chip for receiving switch identification code produced by the decoder 14, to compare the received switch identification code from the decoder 14 with the corresponding switch identification code stored in the memory 12, and to switch on the corresponding switch element 15 when the switch identification codes under comparison are matched, thereby causing the corresponding switch element 15 to turn on the respective electrical apparatus. Therefore, the switch signal from the remote-controller has an identification capability; i.e., one remote-controller is capable of identifying and controlling multiple switch elements 15. Furthermore, the processor 11 drives a respective indicator light 17 to indicate the operation status of the corresponding switch element 15. The switch element 15 can be a relay to be opened/closed subject to the control of the processor 11, or a power switch to be controlled by the processor 11 to regulate output power value to the corresponding electrical apparatus.

Based on microprocessor chip's data processing capability, the processor 11 is able to drive the electronic switch 10 into a learning mode subject to the setting of the set button 16. Under this learning mode, the processor 11 can write a (or a multiple) received switch identification code(s) from the decoder 14 into the memory 12, and corresponds written switch identification code to the corresponding switch element 15. For example, under the learning mode, a user can chose a button of a remote-controller (no shown in the figures) to emit a signal with a switch identification code to the electronic switch 10 in order to make the electronic switch 10 save the switch identification code. Therefore, the user can use the remote-controller to control one of switch element 15. The advantage of the learning mode of the electronic switch 10 is to let a user decide the corresponding relationship between a remote-controller/a button of a remote-controller with electronic switch 10/a switch element 15 of the electronic switch 10. Thus, the electronic switch 10 is provided with the function of learning switch identification code that facilitates the installation and use of the electronic switch 10.

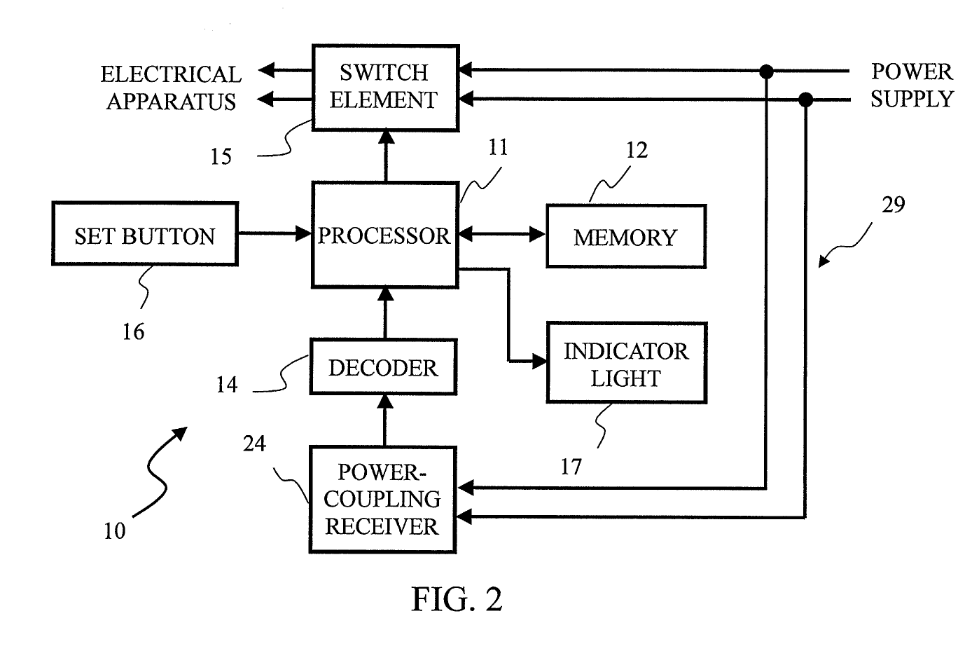

With reference to FIG. 2, there is shown a second preferred embodiment of the electronic switch 10 in accordance with the present invention. This electronic switch 10 is similar to the one shown in FIG. 1 except that the transmission of switch signal is accomplished through an external power line 29. According to this embodiment, the receiver is a power-coupling receiver 24 for receiving external switch signal carried on the power line 29. This embodiment enables switch signal to be transmitted through the power line 29 to control electrical apparatuses installed in different places.

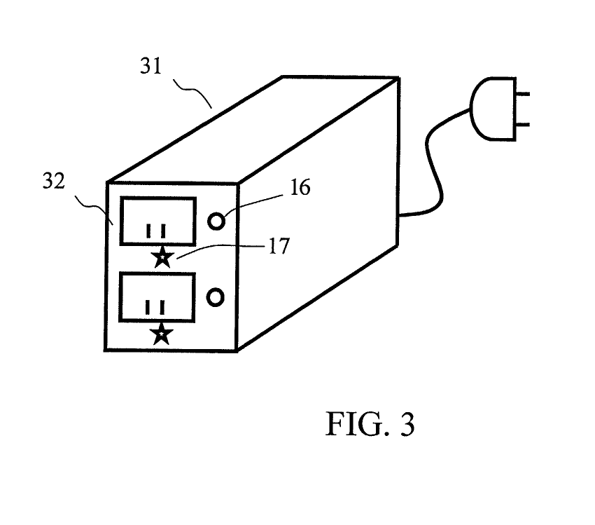

Practically, the electronic switch 10 with code learning and decoding functions in accordance with the present invention can be implemented subject to the design shown in FIG. 3. As shown, the electronic switch 10 is a switch box 31 having two electrical sockets 32, each corresponding to a set button 16, and an indicator light 17. The electrical socket 32 is corresponding to the switch element 15 shown in FIG. 1 or 2. By means of controlling the switch element 15, the respective electrical apparatus at the electrical socket 32 is suitably controlled. Because the electronic switch 10 with code learning and decoding functions is simply formed of integrated circuit elements, the dimension can be small. Moreover, the electronic switch 10 can be designed to be a built-in type switch 41 installed in a wall socket 42.

Although the present invention has been explained in relation to its preferred embodiments, it is to be understood that many other possible modifications and variations can be made without departing from the spirit and scope of the invention as hereinafter claimed.

What is claimed is:

1. An electronic switch comprising:
at least one switch element;
a receiver for receiving an external switch signal and producing a switch control signal upon receipt of an external switch signal;
a decoder for receiving said switch control signal from said receiver and producing a decoding signal containing a switch identification code;
a memory for storing at least one switch identification code, each corresponding to said at least one switch element, respectively; and
a processor for comparing said switch identification code from said decoder with the at least one switch identification code stored in said memory and to turn on the corresponding switch element when the switch identification codes are matched, wherein the processor has a learning mode for saving switch identification code.

2. The electronic switch as claimed in claim 1 further comprising a set button connected to said processor for driving said processor into said learning mode.

3. The electronic switch as claimed in claim 1, wherein said memory is a flash memory.

4. The electronic switch as claimed in claim 1, wherein said memory is an electronically erasable programmable read-only memory.

5. The electronic switch as claimed in claim 1, wherein said receiver is an infrared receiver for receiving external infrared switch signal.

6. The electronic switch as claimed in claim 1, wherein said receiver is a radio receiver for receiving external radio switch signal.

7. The electronic switch as claimed in claim 1, wherein said receiver is a power-coupling receiver for receiving external switch signal from a power line.

8. The electronic switch as claimed in claim 1, wherein said at least one switch element is a relay.

9. The electronic switch as claimed in claim 1, wherein said at least one switch element is a power switch for being controlled by said processor to regulate output power value.

10. The electronic switch as claimed in claim 1, wherein said processor is a microprocessor chip.
